(19) United States
(12) Patent Application Publication
(10) Pub. No.: US 2015/0302418 A1
(43) Pub. Date: Oct. 22, 2015

(54) Internet Content Error Reporting Website for Crowd Sourced Proofreading with Duplicate Report Prevention Feature and Suggestion Submission Feature

(71) Applicant: Orin Andre Roberson, Houston, TX (US)

(72) Inventor: Orin Andre Roberson, Houston, TX (US)

(21) Appl. No.: 14/257,968

(22) Filed: Apr. 21, 2014

(51) Int. Cl. G06Q 30/00; G06Q 50/00; G06Q 20/14

(52) U.S. Cl. CPC G06Q 30/018; G06Q 20/145; G06Q 50/01

(57) ABSTRACT

A method and system is an Internet Content Error Reporting Website for Crowd Sourced Proofreading with Duplicate Report Prevention Feature and Suggestion Submission Feature. The website allows registered website owners to place a bounty or offer a cash reward for identification of errors and potential improvements that can be done to websites and other digital media. The bounty feature allows the owner of the media to determine and limit the number of items, the category, scope of the help that is requested, the price to be paid for instances of valid help and other pertinent features such as but not limited to duration and pages and sections of the digital media targeted.

### CROSS-REFERENCE TO RELATED APPLICATION

This provisional patent application is related to provisional patent application No. ______ filed on Apr. 19, 2013. The contents of this application are incorporated herein by reference.

### FIELD OF THE INVENTION

This invention relates to a method and system for editing a website and in particular, this invention relates to a method and system in which websites are reviewed and errors detected by persons visiting the website.

### BACKGROUND OF THE INVENTION

Millions of websites are created and are online today. In addition, website owners constantly change their sites to keep the information current. With the many changes that occur to website typing mistakes are routinely missed by editing programs. In many instances, mistakes are detected and corrected. However, in many other situations, these mistakes remain on the site. When basic mistakes such typing errors remain on a website, some website visitors may reach certain negative conclusions about the website and the business or other entity that the site represents. There remains a need for a method and system for enhanced detection and correction of website errors.

### SUMMARY OF THE INVENTION

The present invention is a method and system is an Internet Content Error Reporting Website for Crowd Sourced Proofreading with Duplicate Report Prevention Feature and Suggestion Submission Feature. In this invention, the website allows registered website owners to place a bounty or offer a cash reward for identification of errors and potential improvements that can be done to websites and other digital media. The bounty feature allows the owner of the media to determine and limit the number of items, the category, scope of the help that is requested, the price to be paid for instances of valid help and other pertinent features such as but not limited to duration and pages and sections of the digital media targeted.

The website allows owners of the digital media to specify the type of help needed and reply to those seeking to help in an open forum to assist in clarity of decisions. The website provides the media owner the opportunity to choose the proper payment election that fits the level of the validity of reports.

### DESCRIPTION OF THE DRAWINGS

FIG. 1 is a flow diagram of the general steps of the invention in which a hunter signs up for participation in the process of the present invention.

FIG. 2 is a flow diagram of the general steps of the invention illustrating a hunter ad and user and advertiser interaction.

FIG. 3 is a flow diagram of the general steps of the invention illustrating a business sign up and advertising creation.

FIG. 4 is a flow diagram of the general steps of the invention illustrating a charity and nonprofit sign up.

FIG. 5 is a flow diagram of the general steps of the invention for handling error reporting.

FIG. 6 is a flow diagram of the general steps of the invention for reporting the review process.

FIG. 7 is a flow diagram of the steps of the invention for interaction with errors identified on a website.

FIG. 8 is a flow diagram of the steps of the invention referral and head start for finding errors.

### DESCRIPTION OF THE INVENTION

The present invention is a method and system is an Internet Content Error Reporting Website for Crowd Sourced Proofreading with Duplicate Report Prevention Feature and Suggestion Submission Feature. In this invention, the website allows registered website owners to place a bounty or offer a cash reward for identification of errors and potential improvements that can be done to websites and other digital media. The bounty feature allows the owner of the media to determine and limit the number of items, the category, scope of the help that is requested, the price to be paid for instances of valid help and other pertinent features such as but not limited to duration and pages and sections of the digital media targeted.

The website allows owners of the digital media to specify the type of help needed and reply to those seeking to help in an open forum to assist in clarity of decisions. The website provides the media owner the opportunity to choose the proper payment election that fits the level of the validity of reports. The system/website allow for the tracking of both positive and negative interactions with regard to reports being filed and reports being handled. Both sides of the transaction are governed by a penalty system that encourages fairness.

The system allows internet users to register for an account and hunt for writing and website errors including but not limited to typographical errors, misspellings, poor grammar, missing graphics, broken links and others for a chance to earn a monetary rewards which they can use as coupons toward the purchase of products and or donations to charitable organizations or other nonprofits.

Internet users can compete against one another for the position of top hunter as noted by the most earnings or the best team earnings using the custom toolbar which allows them to perform such actions as but not limited to, reporting problems, refer websites, claim errors and review writing resources.

The website/system allows nonprofit organizations to sign up to receive the donations that internet users that have registered donate as they hunt for errors and chances to help online. The system provides advertisers a unique advertising advantage by raising the attention levels, visitor stay times, increased website traffic, and lowered buy defenses through the game feature/gamification of internet users looking for opportunities to help proofread for monetary rewards and competition.

The website/system raises internet ad click-through rates. Increases consumer attention levels and lowers consumer buy defenses to near zero levels, Helps businesses communicate product and service benefits more effectively. Solves advertising blindness problem in consumers, Helps consumers earn money to help pay for the products they want, Coupons encourage consumers to buy products, helps retailers sell more product due to people knowing more about their products, helps the common man become a consistent philanthropist without feeling the financial pinch, helps charities, churches and other nonprofits raise money for their causes, redefines market shares for online newspapers, blogs, and websites, a game feature allows internet users to show how smart they are, make a difference and compete with others in the game of identifying mistakes, proofreading and documentation correction service, improves the quality of the internet, all in one package.

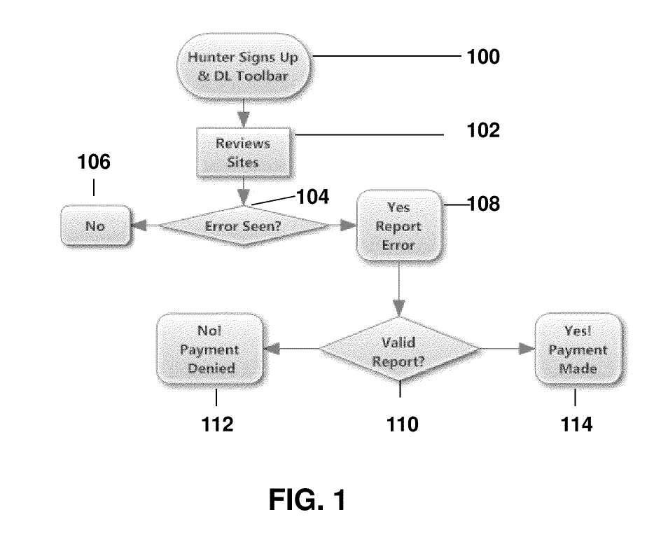

FIG. 1 is a flow diagram of the general steps of the invention in which a hunter signs up for participation in the process of the present invention. In this invention, In this method, a hunter signs up in step 100 and review the site in step 102. If there is no detected error in step 104, the user continues in step 106 to review the site. If an error is detected, the user issues a report in step 108. Step 110 determines if the report is valid. If the determination is that the report is valid, step 114 makes a payment to the user. If in step 110, the determination is that the report is not valid, step 112 denies the payment.

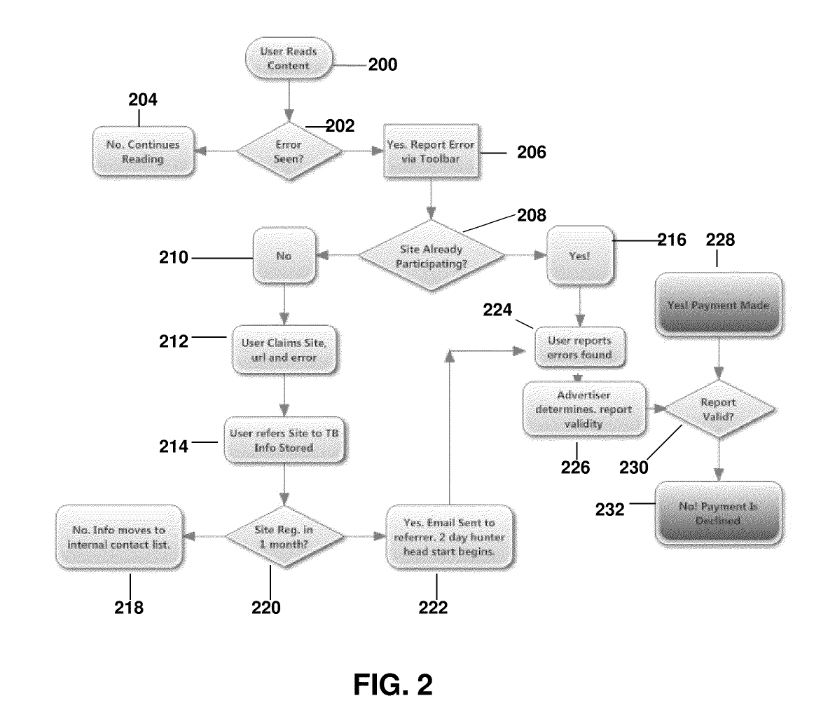

FIG. 2 is a flow diagram of the general steps of the invention illustrating a hunter ad and user and advertiser interaction. This method describes an actual review of a site by a user. The user continues to review a site until an error is detected or the user reaches the end of the document.

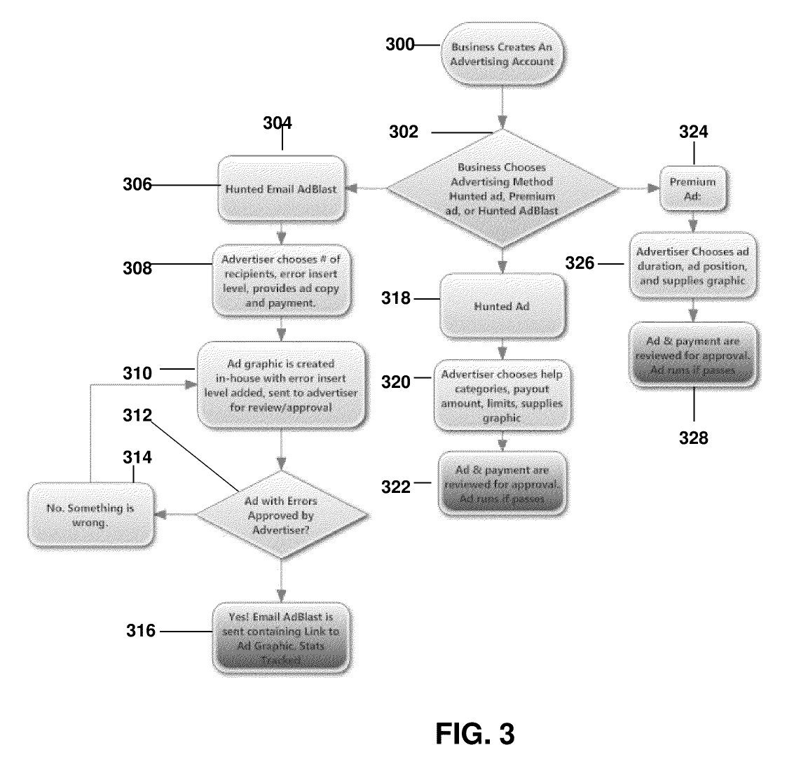

FIG. 3 is a flow diagram of the general steps of the invention illustrating a business sign up and advertising creation.

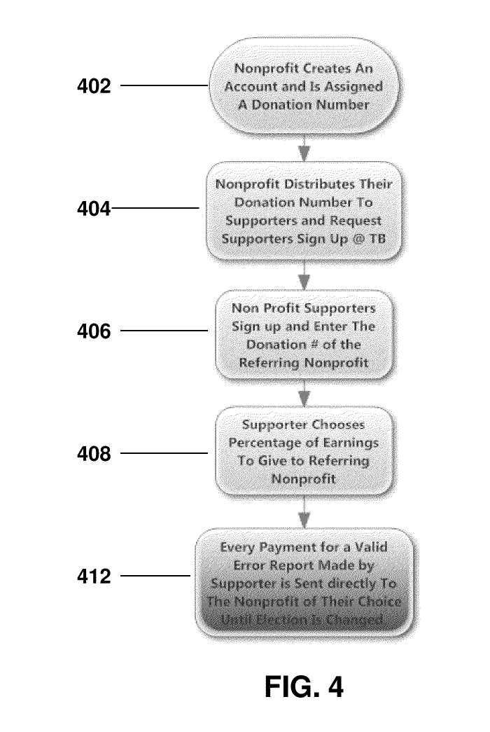

FIG. 4 is a flow diagram of the general steps of the invention illustrating a charity and nonprofit sign up.

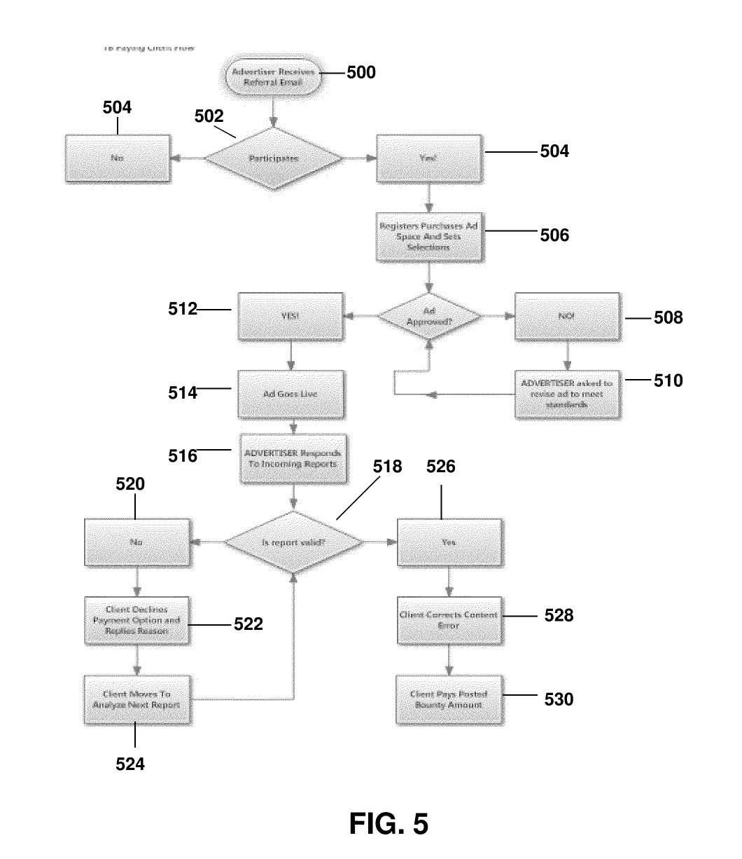

FIG. 5 is a flow diagram of the general steps of the invention for handling error reporting.

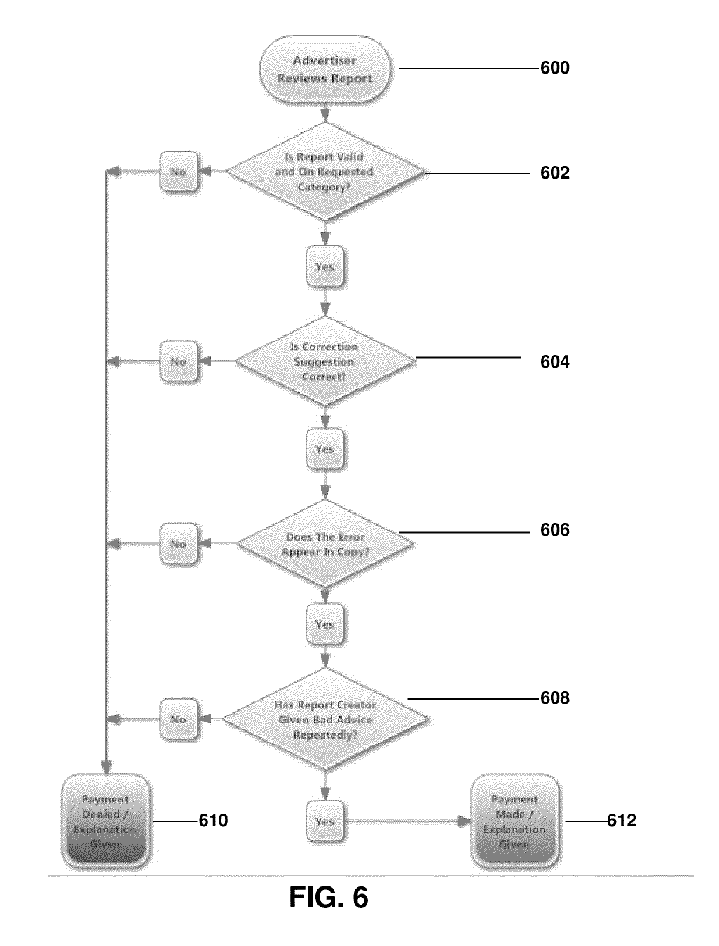

FIG. 6 is a flow diagram of the general steps of the invention for reporting the review process.

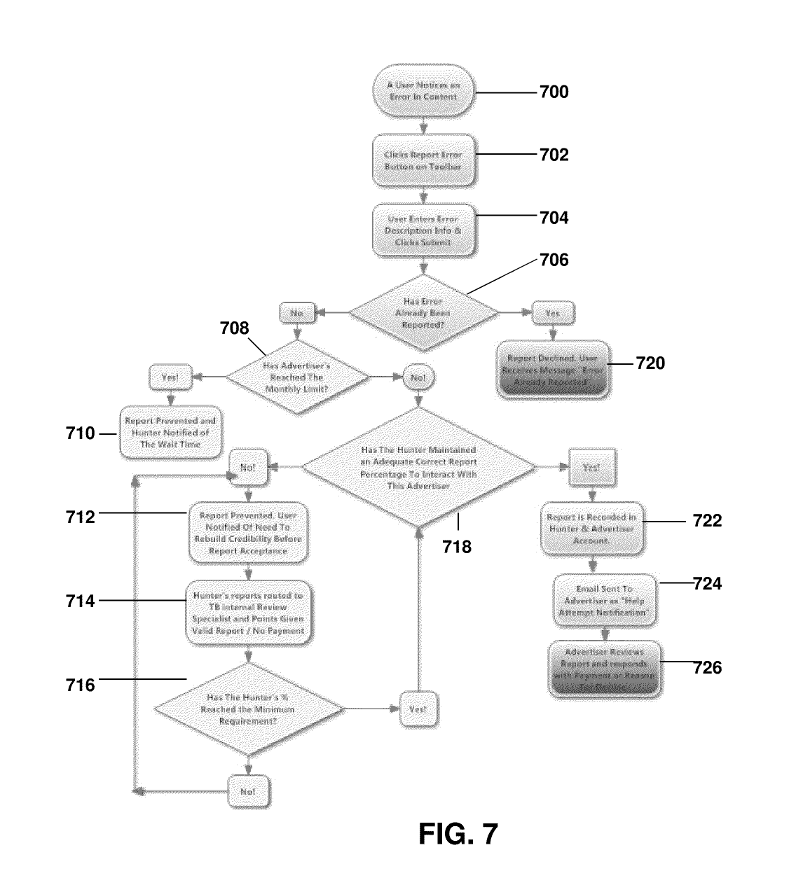

FIG. 7 is a flow diagram of the steps of the invention for interaction with errors identified on a website.

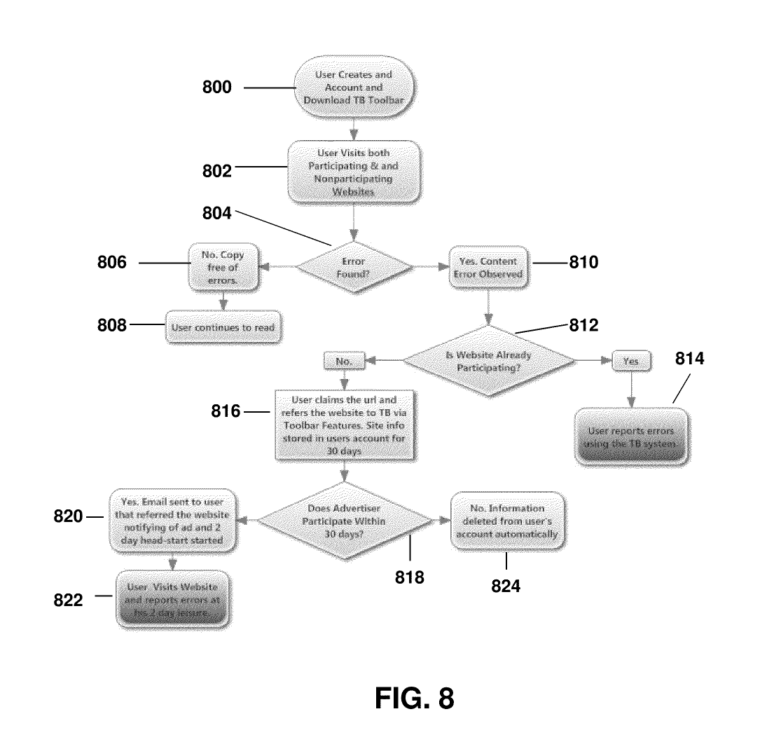

FIG. 8 is a flow diagram of the steps of the invention referral and head start for finding errors.

It is important to note that while the present invention has been described in the context of a fully functioning data processing system, those skilled in the art will appreciate that the processes of the present invention are capable of being distributed in the form of instructions in a computer readable storage medium and a variety of other forms, regardless of the particular type of medium used to carry out the distribution. Examples of computer readable storage media include media such as EPROM, ROM, tape, paper, floppy disc, hard disk drive, RAM, and CD-ROMs.

I claim:

1. A method for internet content error reporting for crowd sourced proofreading with duplicate report prevention feature comprising;
identifying contents of a website for review;
reviewing the identified contents of the identified website;
determining if an error in the contents of the website;
when an error is determined for the contents of the website generating a report of the error;
determining if the generated report is valid; and
making a payment to user when the determination is that the report is valid.

2. A method for internet content error reporting for crowd sourced proofreading with duplicate report prevention feature comprising;
identifying contents of a website for review;
reviewing the identified contents of the identified website;
determining if an error in the contents of the website;
when an error is determined for the contents of the website generating a report of the error;
determining if the generated report is valid; and
denying a payment to user when the determination is that the report is not valid.
